(19) United States
(12) Patent Application Publication
(10) Pub. No.: US 2020/0059119 A1
(43) Pub. Date: Feb. 20, 2020

(54) SYSTEMS AND METHODS FOR TRANSMITTER TO RECEIVER COMMUNICATION FOR OUTPUT VOLTAGE SETTING IN WIRELESS POWER TRANSFER

(71) Applicant: ChargEdge, Inc., Fremont, CA (US)

(72) Inventor: Sanjaya Maniktala, Fremont, CA (US)

(21) Appl. No.: 16/544,495

(22) Filed: Aug. 19, 2019

Related U.S. Application Data
(60) Provisional application No. 62/719,611, filed on Aug. 18, 2018.

(51) Int. Cl. H02J 50/80; H02J 50/12; H02J 7/02

(52) U.S. Cl. CPC H02J 50/80; H02J 7/025; H02J 50/12

(57) ABSTRACT

Systems and methods are provided for operating a wireless power transmitter where the wireless power transmitter is configured to generate a magnetic flux for wirelessly charging a remote wireless power receiver. The wireless power transmitter receives a signal from the remote wireless power receiver that indicates a voltage level at which to charge the remote wireless power receiver. The wireless power transmitter determines a current level to be supplied to a coil of the wireless power transmitter based on the voltage level at which to charge the remote wireless power receiver and one or more properties of the wireless power transmitter. And the wireless power transmitter generates the magnetic flux by energizing the coil of the wireless power transmitter at the determined current level.

### CROSS-REFERENCE TO RELATED APPLICATION

This application claims the benefit of U.S. Provisional Patent Application No. 62/719,611, entitled “Transmitter to Receiver Communication for Output Voltage Setting,” filed on Aug. 18, 2018 the subject matter of which is hereby incorporated by reference in its entirety.

### FIELD OF THE INVENTION

The present invention generally relates to systems and methods for communications between a wireless power transmitter and a wireless power receiver to set an output voltage in a wireless power receiver.

### BACKGROUND

Electronic devices typically require a connected (wired) power source to operate, for example, battery power or a wired connection to a direct current (“DC”) or alternating current (“AC”) power source. Similarly, rechargeable battery-powered electronic devices are typically charged using a wired power-supply that connects the electronic device to a DC or AC power source. The limitation of these devices is the need to directly connect the device to a power source using wires.

Wireless power transfer (WPT) involves the use of time-varying magnetic fields to wirelessly transfer power from a source to a device. Faraday's law of magnetic induction provides that if a time-varying current is applied to one coil (e.g., a transmitter coil) a voltage will be induced in a nearby second coil (e.g., a receiver coil). The voltage induced in the receiver coil can then be rectified and filtered to generate a stable DC voltage for powering an electronic device or charging a battery. The receiver coil and associated circuitry for generating a DC voltage can be connected to or included within the electronic device itself such as a smartphone or tablet.

The Wireless Power Consortium (WPC) was established in 2008 to develop the Qi inductive power standard for charging and powering electronic devices. Powermat is another well-known standard for WPT developed by the Power Matters Alliance (PMA). The Qi and Powermat near-field standards operate in the frequency band of 100-400 kHz. The problem with near-field WPT technology is that typically only 5 Watts of power can be transferred over the short distance of 2 to 5 millimeters between a power source and an electronic device, though there are ongoing efforts to increase the power. For example, some concurrently developing standards achieve this by operating at much higher frequencies, such as 6.78 MHz or 13.56 MHz. Although they are called magnetic resonance methods instead of magnetic induction, they are based on the same underlying physics of magnetic induction. There also have been some market consolidation efforts to unite into larger organizations, such as the AirFuel Alliance consisting of PMA and the Rezence standard from the Alliance For Wireless Power (A4WP), but the technical aspects have remained largely unchanged.

Typical wireless power transfer receivers communicate with wireless power transfer transmitters using amplitude modulation, also known as “backscatter” or “inband” communication. For higher power wireless power transfer systems, where up to 15 Watts of power can be transferred, the Qi standard utilizes frequency modulation (e.g., frequency shift key modulation) for wireless power transfer receivers to communicate with wireless power transfer transmitters. In such systems, the wireless power transfer transmitter communicates with the wireless power transfer receiver by varying the operating frequency of the transmitter. The varied frequency is demodulated by the receiver to interpret the information from the transmitter to the receiver.

There are several drawbacks with the frequency shift key modulation approach of the Qi standard. In some cases, the frequency key modulation approach of the Qi standard transmits redundant information from the transmitter to the receiver. Further, frequency modulation requires high-frequency demodulation circuitry in the receiver, and in some implementations requires higher frequency capabilities for a microcontroller of the receiver. This increases the costs associated with designing and producing wireless power transfer receivers.

Other wireless power standards use separate communication channels for wireless power transfer receivers to communicate with wireless power transfer transmitters. For example, the Rezence standard uses the Bluetooth communication protocol to communicate between wireless power transfer receivers and wireless power transfer transmitters. Using a separate channel, such as the Bluetooth communication protocol, requires both the wireless power transfer receiver and the wireless power transfer transmitter to have Bluetooth transceiver microchips, increasing the costs associated with designing and producing wireless power transfer receivers and wireless power transfer transmitters.

Thus, there is a long felt need for an improved technique for simplifying communications between a wireless power transmitter and a wireless power receiver to reduce the complexity of the communication circuitry needed in both the wireless power transmitter and the wireless power receiver, and to reduce the redundant information sent when communicating between the wireless power receiver and the wireless power transmitter.

### BRIEF DESCRIPTION OF THE INVENTION

In an aspect, a method of operation of a wireless power transmitter, the wireless power transmitter configured to generate a magnetic flux for wirelessly charging a remote wireless power receiver. The method includes receiving a signal from the remote wireless power receiver that indicates a voltage level at which to charge the remote wireless power receiver, determining a current level to be supplied to a coil of the wireless power transmitter based on the voltage level at which to charge the remote wireless power receiver and one or more properties of the wireless power transmitter, and generating the magnetic flux by energizing the coil of the wireless power transmitter at the determined current level.

In another aspect, a wireless power transmitter, the wireless power transmitter configured to generate a magnetic flux for wirelessly charging a remote wireless power receiver, the wireless power transmitter includes a coil, a power converter configured to supply a current to the coil, and a controller. The controller is configured to receive a signal from the remote wireless power receiver that indicates a voltage level at which to charge the remote wireless power receiver, determine a current level to be supplied to the coil based on the voltage level at which to charge the remote wireless power receiver and one or more properties of the wireless power transmitter, and instruct the power converter to supply the determined current level to the coil to generate the magnetic flux by energizing the coil.

### BRIEF DESCRIPTION OF THE FIGURES

FIG. 1 is a diagram of one embodiment of a wireless power system, according to certain implementations;

FIG. 2 is a diagram of one embodiment of the wireless power receiver of FIG. 1, according to certain implementations;

FIG. 3 is a plot of the voltage over time, according to certain implementations;

FIG. 4 is a flow chart of a process for communicating between a wireless power transmitter and a wireless power receiver, according to certain implementations.

### DETAILED DESCRIPTION

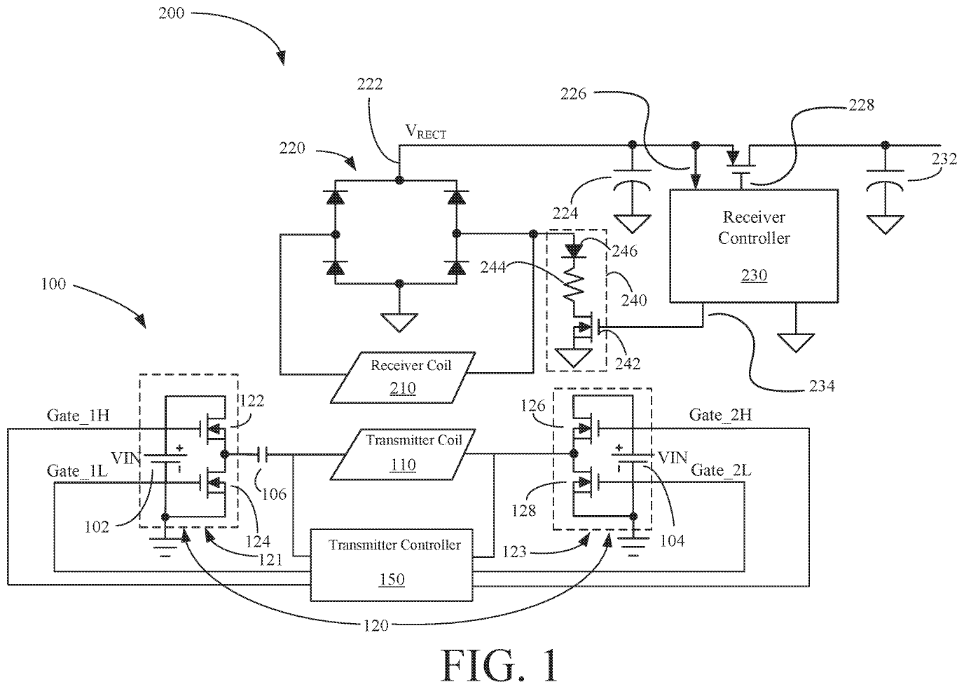

FIG. 1 is a diagram of one embodiment of a wireless power system. The wireless power system includes wireless power transmitter 100 and wireless power receiver 200. Wireless power transmitter 100 includes, but is not limited to: a direct current (DC) voltage supply 102 and 104, resonant capacitor 106, transmitter coil 110, converter circuit 120 (e.g., converter 120) that is comprised of half-bridge converter 121 and half bridge converter 123, and transmitter controller 150.

Converter 120 is comprised of two half-bridge converters, half-bridge converter 121 that comprises transistors 122 and 124, and half-bridge converter 123 that comprises transistors 126 and 128. Thus, converter 120 is a full-bridge converter comprises of transistors 122, 124, 126, and 128. The converter 120 generates an AC signal output through resonant capacitor 106 and transmitter coil 110 from an input DC voltage applied to the converter circuit 120 via input voltage supply 102, input voltage supply 104, or a combination of input voltage supplies 102 and 104. The generated AC signal can be, but is not limited to, a square wave, a sinusoidal wave, a triangular wave, or a sawtooth wave.

Voltage supply 102, voltage supply 104, or a combination of voltage supplies 102 and 104 provides a DC input voltage for transmitter 100, and in one embodiment the input voltage is a constant value chosen from the range of 12-15 V. For example, in some embodiments, the input voltage is 12 V. In some embodiments, such as in electric vehicle charging, the input voltage can be much higher, up to 500 V. Any input voltage is within the scope of this disclosure.

In another embodiment, not illustrated in FIG. 1, voltage supply 102, voltage supply 104, or a combination of voltage supplies 102 and 104, is implemented as a DC-to-DC converter that provides a variable DC input voltage to converter 120. Transmitter controller 150 provides a control signal to the DC-to-DC converter select the input voltage value.

In other embodiments, as illustrated in FIG. 1, the input voltage value to transmitter coil 110 and capacitor 106 may be varied by duty cycle control or phase modulation of full-bridge converter 120 by transmitter controller 150. In other embodiments, not illustrated in FIG. 1, a variable input voltage from voltage supply 102, a variable input voltage from voltage supply 104, a combination of a variable input voltage from voltage supplies 102 and 104, duty cycle variation, and/or phase modulation may be used to vary the voltage input to transmitter coil 110 and capacitor 106.

The capacitance of capacitor 106 and the total inductance of transmitter coil 110 determines the resonant frequency of transmitter 100. Transmitter coil 110 can be formed of wires or traces on a printed circuit board using conductive material such as copper, gold, or any other conductive material known in the art. Transmitter coils are further described in U.S. Patent Publication No. 20160285317 A1, entitled “Wireless Power Transfer Using Multiple Coil Arrays,” filed on Mar. 28, 2016, the subject matter of which is hereby incorporated by reference in its entirety.

Wireless power receiver 200 includes, but is not limited to: receiver coil 210, rectifier 220, capacitor 224, voltage sensing circuitry 226, series switch 228, receiver controller 230, capacitor 232, and communication circuitry 240. In some implementations, receiver coil 210 includes a ferrite core and a helical coil. For example, the ferrite core may be in the shape of a cylindrical rod and a helical coil is wrapped around the ferrite core such that the ferrite core and the helical coil have a common longitudinal axis. As another example, the ferrite core may be parallelepiped or other shape, or may be made of a flexible ferrite sheet. The helical coil is preferably formed of a wire made from a conductive material such as copper, gold, or any other conductive material known in the art. Wireless power receivers and receiver coil structures are described in more detail in in U.S. Patent Publication No. 20170256990 A1, entitled “Receiver Coil Arrangements for Inductive Wireless Power Transfer for Portable Devices,” filed on Mar. 2, 2017, the subject matter of which is hereby incorporated by reference in its entirety.

Receiver coil 210 orients itself parallel in the y-direction to transmitter coil 110 such that flux lines of the magnetic field produced by transmitter 100 pass through receiver coil 210. For example, the ways the receiver coil 210 orients itself in relation to transmitter coil 110 such that the flux lines pass through receiver coil 210 are further described in U.S. Patent Publication No. 20170256990 A1, entitled “Receiver Coil Arrangements for Inductive Wireless Power Transfer for Portable Devices.” Faraday's law provides that the time-varying current that flows in receiver coil 210 will oppose the magnetic field generated by a transmitter coil 110. Thus, flux lines passing through receiver coil 210 cause a time-varying current to flow in receiver coil 210. Receiver coil 210 is coupled to rectifier 220 such that a time-varying current is input to rectifier 220. In some embodiments, receiver coil 210 is a single or dual flat spiral coil, such as described in FIGS. 8 and 9 of U.S. Patent Publication No. 20160285317 A1, entitled “Wireless Power Transfer Using Multiple Coil Arrays.” Receiver coil 210 is aligned with the transmitter coil 110 which in turn can be a single, or dual coil spiral, such as described in U.S. Patent Publication No. 20160285317 A1, entitled “Wireless Power Transfer Using Multiple Coil Arrays.”

Rectifier 220 receives a time-varying current output from receiver coil 210. Rectifier 220 generates a rectified voltage at 222 from the time-varying current. The rectified voltage is a DC voltage. In some embodiments, the rectifier 220 comprises four diodes, as shown in FIG. 1.

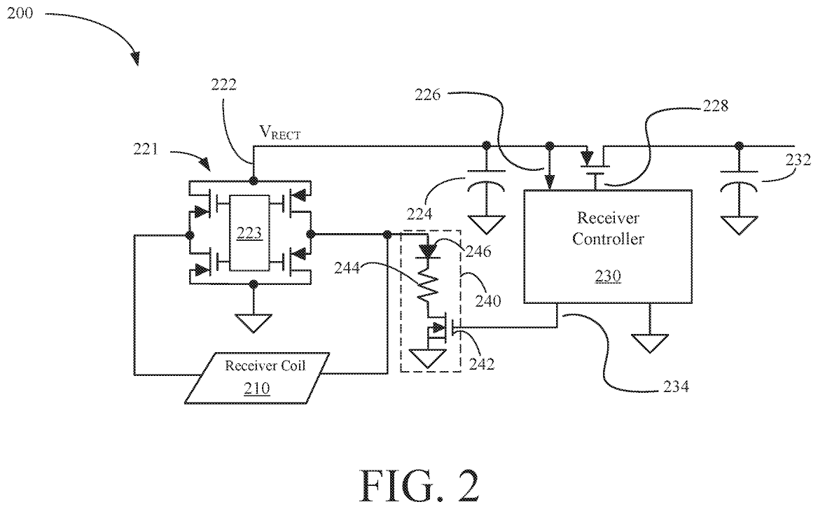

In another embodiment shown in FIG. 2, rectifier 220 is replaced with a rectifier bridge 221 that includes four MOSFETs (metal oxide semiconductor field-effect transistors), which is sometimes called an “active bridge” or “synchronous bridge.” Rectifier bridge 221 comprises control circuit 223 that turns on (i.e., conducting) a MOSFET in an active bridge when its body diode begins to conduct. Control circuitry 223 turns off (i.e., non-conducting) the MOSFET when its body diode becomes or is about to become reverse-biased. In this embodiment, the forward voltage drop across the body diode of each conducting MOSFET is smaller than the forward voltage drop across a typical diode because of the relatively low resistance of a conducting MOSFET. In another embodiment, each of the four MOSFETs in an active bridge is configured to be non-conducting such that its body diode dictates its operation.

Capacitor 224 is coupled to the output of rectifier 220. Capacitor 224 converts the full-wave rippled output of rectifier 220 into a DC output voltage, wherein the capacitor 224 filters out the AC components of the rippled output of rectifier 220. In some embodiments, capacitor 224 can be comprised of multiple capacitors in parallel.

At voltage sense 226, the filtered, rectified voltage from capacitor 224 is input to the receiver controller 230. For example, voltage sense 226 may be a v_sense pin communicatively coupled to receiver controller 230. As another example, voltage sense 226 may be a capacitive-type voltage sensor where the voltage is measured across a capacitor, or a resistive-type voltage sensor where the voltage is measured across a resistor. In some embodiments, a resistive divider may be coupled between voltage sense 226 and receiver controller 230 to step down the rectified voltage input into receiver 230. For example, a resistive divider may comprise two resistors (e.g., R1 and R2) in series between voltage sense 226 and receiver controller 230 such that the voltage at receiver controller 230 is equal to V_{controller}=Vₛₑₙₛₑ*R1/(R1+R2). In some embodiments, the resistive divider may be part of the receiver controller 230. For example, the resister divider may be configured to step down a rectified voltage of 20 V with a current of 5 A (e.g., 100 W of power) to a voltage of 5 V and current of 20 A. The design of the resistive divider is dependent on the design and parameters of the receiver 200.

The receiver controller 230 may output wireless communication signals at 234 to wireless power transmitter 100 via communications circuitry 240. Receiver controller 230 output communications to wireless power transmitter 100 via amplitude modulation of a signal. Amplitude modulation is also referred to as “backscatter” or “in-band” communication.

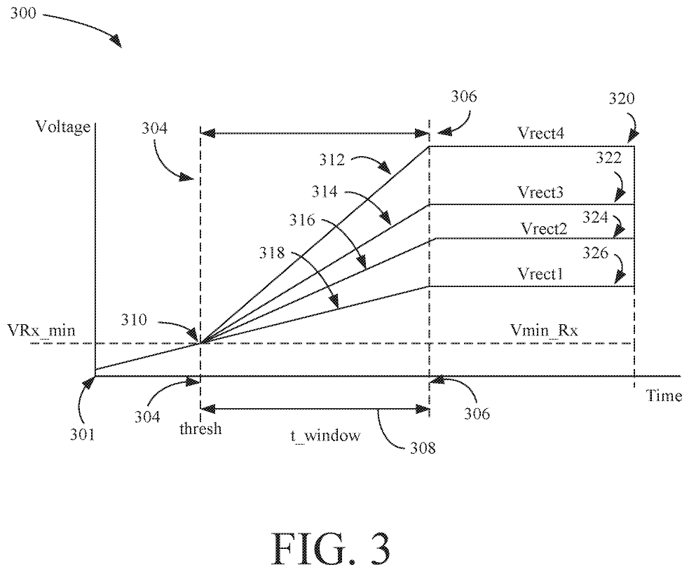

In some embodiments, amplitude shift keying (ASK) is used to send wireless communication signals from receiver controller 230 to transmitter 100. Amplitude shift keying may be implemented via communications circuitry 240. For example, communications circuitry 240 may comprise a transistor 242, a resistor 244, and a diode 246 to produce resistive or load modulation. Alternatively, the resistor and diode may be replaced with a capacitor of typical value 0.1 uF to produce capacitive modulation. The communications circuitry may in general consist of a combination of resistive and capacitive modulation methods, coupled or directly connected between one or both ends of the receiver coil 210, and the rectified ground of the receiver. Receiver controller 230 may configure transistor 242 within communications circuitry 240 to operate as a switch. Receiver controller 230 may configure the switch to modulate the amplitude of a wireless communication signal output from receiver controller 230 to transmitter 100. Transmitter and receiver communication will be discussed in more detail in reference to FIG. 3.

Receiver controller 230 is further configured to control series pass switch 228 coupled to receiver controller 230. In some implementations, series pass switch 228 may be implemented as a p-channel field effect transistor (FET). The series pass switch 228 may be implemented as a transistor, a bipolar junction transistor (BJT), a n-channel FET, a p-channel FET, or any other comparable switch. When receiver controller 230 configures series pass switch 228 to be “closed,” the filtered, rectified voltage at 226 is output across capacitor 232. For example, when series pass switch 228 is a transistor, such as a p-channel FET, the series pass switch 228 is “closed” when the p-channel FET operates in the saturation region, where the gate-to-source voltage of the p-channel FET is greater than the threshold voltage of the p-channel FET. When receiver controller 230 configures series pass switch 228 to be “open,” capacitor 232 becomes an open circuit where no voltage is output across capacitor 232. For example, when series pass switch 228 is a transistor, such as a p-channel FET, the series pass switch 228 is “open” when the p-channel FET operates in the cut-off region, where the gate-to-source voltage of the p-channel FET is less than the threshold voltage of the p-channel FET. The voltage output across capacitor 232 may be used to power a device, charge a battery, etc. The use of a series pass switch 228 effectively disconnects the load (e.g., the device, the battery, etc.) from the front end of the receiver circuitry (e.g., receiver coil 210, rectifier 220 or rectifier 221 and controller 223, capacitor 224, receiver controller 230, and communications circuitry 240) for the duration of the wireless communication as described in this disclosure, so that the load characteristics do not affect the rate of rise of the rectified receiver voltage until a decision has been made by the receiver 200 based on the rate of rise receiver 200 experiences.

FIG. 2 is a diagram of one embodiment the wireless power receiver 200 of FIG. 1. The wireless power receiver 200 in FIG. 2 has the same functionalities as described in respect to FIG. 1.

FIG. 3 is a plot of the voltage over time during a wireless power receiver to wireless power transmitter communication, according to certain implementations. Plot 300 shows voltage on the y-axis and time on the x-axis. At 301, receiver 200 beings to power-on, and generates a rectified voltage from the time-varying current that flows in receiver coil 210 and opposes the magnetic field generated by transmitter coil 110. Transmitter 100 may slowly increase the strength of the magnetic field by increasing the current flowing through transmitter coil 110 and/or by increasing the voltage across transmitter coil 110, which increases the rectified voltage generated from the time-varying current in the receiver coil 210. At time 304, the rectified voltage at voltage sense 226 “wakes-up” receiver controller 230. The rectified voltage at time 304 is the threshold voltage 310 (e.g., minimum rectified voltage) needed to power-on receiver 200. In some embodiments, the threshold voltage 310 is 3.3 V or 5 V, based on the requirements and properties of receiver 200. For example, the threshold 310 may correspond to the minimum voltage required for receiver controller 230 to power-on.

At time 304, after receiver 200 receives the minimum required voltage to power-on, receiver controller 230 sends a first wireless communication signal to transmitter 100 via communication circuitry 240. For example, receiver controller 230 may send a first packet of data to transmitter 100 through communications circuitry 240 via amplitude shift keying in the 2 kHz to 4 kHz bandwidth. The wireless communication signal (e.g., the first packet of data) may contain information about receiver 200. In some embodiments, the wireless communication signal may include the identity of receiver 200, the minimum voltage required for receiver 200 to power-on, a maximum rectified voltage that receiver 200 is configured to accept, and/or a period of time over which transmitter 100 is to increase the power transmitted to receiver 200. In some embodiments, receiver controller 230 may retrieve the identity of receiver 200, the minimum voltage required for receiver 200 to power-on, a maximum rectified voltage the receiver 200 is configured to accept, and/or a period of time over which transmitter 100 is to increase the power transmitted to receiver 200 from memory communicatively coupled to receiver controller 230.

In some embodiments, the period of time over which transmitter 100 is to increase the power transmitted to receiver 200 is stored in memory communicatively coupled to transmitter controller 150. For example, when the period of time is stored in memory communicatively coupled to transmitter controller 150, the first communication may only contain a maximum voltage that receiver 200 is configured to accept. That will allow transmitter 100 to set the characteristics of transmitter 100 to deliver less regulated receiver voltage if necessary, than it may be capable of producing, so as not to damage receiver 200.

In some embodiments, the maximum rectified voltage the receiver 200 is configured to accept corresponds to the preferred rectified voltage that the receiver 200 requires based on the load (e.g., device and/or battery properties) that the output voltage across capacitor 232 is output to.

In some embodiments, during the period of time between time 301 and time 304 before the receiver has powered-on, series pass switch 228 is “open” such that no voltage is output across capacitor 232. Thus, receiver 200 does not output a voltage to power a device or charge a battery when receiver 200 receives less than a threshold, minimum voltage 310 needed to power-on receiver 200.

After the first wireless communication signal is received by transmitter 100, transmitter controller 150 demodulates the data packet corresponding to the received wireless communication signal. Transmitter controller 150 coupled to transmitter 100 demodulates the data packet and retrieves the information about receiver 200 in the data packet. For example, after demodulating the data packet, transmitter controller 150 may retrieve the characteristics of receiver 200, such as the identity of receiver 200, the minimum rectified voltage required for receiver 200 to power-on, a maximum rectified voltage the receiver 200 is configured to accept, and/or a period of time over which transmitter 100 is to increase the power transmitted to receiver 200. The period of time over which transmitter 100 is to increase the power transmitted to receiver 200 is time window 308. In some embodiments, the period of time (e.g., time window 308) is between 1-2 seconds. In some embodiments, the period of time is between 0-2 seconds. Any other suitable period of time is within the scope of this disclosure.

After retrieving the characteristics of receiver 200, transmitter controller 150 determines a power to transmit to receiver 200. Transmitter controller 150 determines a current magnitude to be supplied to transmitter coil 110 and/or a voltage magnitude to be supplied across transmitter coil 110 based on the minimum of (1) the maximum voltage receiver 200 is configured to accept and (2) the maximum power transmitter 100 is configured to transmit to receiver 200. For example, if receiver 200 is configured to accept 20 V of rectified voltage and transmitter 100 is configured to transmit a maximum amount of power such that the receiver 200 would receive 10 V of rectified voltage, transmitter controller 150 determines to supply a current magnitude to transmitter coil 110 such that receiver 200 receives 10 V of rectified voltage, as transmitter 100 is not configured to transmit the requested 20 V of rectified voltage. As another example, if receiver 200 is configured to accept 20 V of rectified voltage and transmitter 100 is configured to transmit a maximum amount of power such that receiver 200 would receive 100 V of rectified voltage, transmitter controller 150 determines to supply a current magnitude to transmitter coil 110 such that receiver 200 receives 20 V of rectified voltage.

After determining a current magnitude to be supplied to transmitter coil 110 and/or a voltage magnitude to be supplied across transmitter coil 110 that corresponds to the transmitter determined rectified voltage to be supplied to receiver 200, transmitter controller 150 determines a rate of change of supply a current magnitude to transmitter coil 110 or a rate of change of supplying a voltage magnitude to transmitter coil 110 to increase the rectified voltage at the receiver 200 from the threshold voltage 310 (e.g., the voltage required for receiver 200 to power-on) to the transmitter 100 determined rectified voltage over a period of time (e.g., time window 308). For example, transmitter 100 increases the power (e.g., by increasing the current/voltage supplied to/across transmitter coil 110) delivered to receiver 200 such that the rectified voltage from rectifier 220 increases at the determined rate of change. Transmitter 100 may increase the current/voltage supplied to/across transmitter coil 110 to increase the power delivered to receiver 200 at a controlled, determined rate of change via phase, duty cycle, input voltage regulation, or frequency modulation, depending on how transmitter 100 is implemented.

For example, when the input voltage value to transmitter coil 110 and capacitor 106 is varied by phase modulation of full-bridge rectifier circuit 120 by transmitter controller 150, transmitter controller 150 may determine the rate of change as a function of:

$$\frac{d θ}{dt}$$

Transmitter controller 150 may vary the phase over time to increase the current/voltage supplied to/across transmitter coil 110 to increase the power transmitted to receiver 200 from transmitter 100 in a controlled manner. For example, transmitter controller 150 may increase the phase of the converter circuit 120 linearly over period of time 308 such that the rectified voltage across voltage sense 226 reaches the transmitter-determined rectified voltage.

As another example, when the input voltage value to transmitter coil 110 and capacitor 106 is varied by duty cycle variation of full-bridge rectifier circuit 120 by transmitter controller 150, transmitter controller 150 may determine the rate of change as a function of:

$$\frac{d ( duty cycle )}{dt}$$

Transmitter controller 150 may vary the duty cycle over time to increase the current/voltage supplied to/across transmitter coil 110 to increase the power transmitted to receiver 200 from transmitter 100 in a controlled manner. For example, transmitter controller 150 may increase the duty cycle of the converter circuit 120 linearly over period of time 308 such that the rectified voltage across voltage sense 226 reaches the transmitter-determined rectified voltage.

As yet another example, when the input voltage value to transmitter coil 110 and capacitor 106 is varied by a variable input voltage source 102 and 104, transmitter controller 150 may determine the rate of change as a function of:

$$\frac{d ( input voltage )}{dt}$$

Transmitter controller 150 may vary the input voltage over time to increase the power transmitted to receiver 200 from transmitter 100 in a controlled manner. For example, transmitter controller 150 may increase the input voltage of input voltage supply 102, input voltage supply 104, or a combination of input voltage supplies 102 and 104 linearly over period of time 308 such that the rectified voltage across voltage sense 226 reaches the transmitter-determined rectified voltage.

In some embodiments, transmitter controller 150 may begin to track the resonant frequency of the transmitter 100 after receiving the first wireless communication signal from receiver 200. Transmitter controller 150 may locate and track the resonant frequency of transmitter 100 using the systems and methods described in U.S. patent application Ser. No. 15/882,147, entitled “System and Method for Frequency Control and Foreign Object Detection in Wireless Power Transfer,” filed on Jan. 29, 2018, the subject matter of which is hereby incorporated by reference in its entirety. In some embodiments, transmitter controller 150 may begin to track the resonant frequency of transmitter 100 prior to receiving the first wireless communication signal from receiver 200.

While tracking the resonant frequency of transmitter 100, transmitter controller 150 may increase the power delivered to receiver 200 from transmitter 100 at the determined rate of change for the duration of period of time 308. At the end of the period of time 308, the rectified voltage sensed at voltage sense 226 in receiver 200 is equivalent to the transmitter-determined rectified voltage (e.g., the minimum of (1) the maximum rectified voltage receiver 200 is configured to accept and (2) the maximum power transmitter 100 is configured to transmit to receiver 200) within a margin of error. For example, in some embodiments, the margin of error may be a few hundred millivolts.

When the transmitter-determined rectified voltage is larger, the rate of change is larger, resulting in a steeper linear line in plot 300. For example, slope 312 (e.g., corresponding to a rate of change) is steeper than slopes 314, 316, and 318. Thus, the resulting rectified voltage 320 at voltage sense 226 (e.g., resulting from slope 312) is larger than the resulting rectified voltage 322 (e.g., resulting from slope 314), rectified voltage 324 (e.g., resulting from slope 316), and rectified voltage 326 (e.g., resulting from slope 318).

After reaching the end of period of time 308, at time 306, receiver controller 230 may send subsequent wireless communication signals based on the value of the rectified voltage at voltage sense 226. For example, if the receiver controller 230 initially requested 20 V of rectified voltage and the rectified voltage at voltage sense 226 after time 306 is 19.8 V, receiver controller 230 may send a wireless communication signal via communications circuitry 240 that includes a request for more rectified voltage (e.g., a request to increase the power output from transmitter 100). Transmitter 100 may receive the wireless communication signal and incrementally increase the power until the receiver 200 does not request additional rectified voltage (e.g., does not send additional wireless communication signals requesting more rectified voltage or sends an additional wireless communication signal requesting less rectified voltage). As another example, if the receiver controller 230 initially requested 20 V of rectified voltage and the rectified voltage at voltage sense 226 after time 306 is 20.5 V, receiver controller 230 may send a wireless communication signal via communications circuitry 240 with a request for less rectified voltage. Transmitter 100 may receive the wireless communication signal and incrementally decrease the transmitted power until the receiver 200 does not request less rectified voltage (e.g., does not send additional wireless communication signals requesting less rectified voltage or sends an additional wireless communication signal requesting more rectified voltage).

In some embodiments, if the maximum power transmitter 100 is configured to transmit to receiver 200 is corresponds to a rectified voltage at receiver 200 that is smaller than the maximum rectified voltage receiver 200 is configured to accept, then receiver controller 230 receives a rectified voltage at voltage sense 226 corresponding to the maximum power transmitter 100 is configured to transmit. Receiver controller 230 may determine that the received rectified voltage is the maximum power that transmitter 100 is configured to transmit because it is smaller than the requested, maximum rectified voltage receiver 200 is configured to accept, outside of the margin of error (e.g., between 0-500 mV or between 0-1 V, etc.). In some embodiments, the margin of error is a preset property stored in a memory communicatively coupled to receiver controller 230. Receiver controller 230 may not send subsequent wireless communication signals via communications circuitry 240 requesting more power from transmitter 100 because receiver controller 230 has determined that transmitter 100 is not capable of transmitting more power. Receiver controller 230 may reconfigure the load (e.g., device and/or battery requirements) that the rectified voltage is output to.

In some embodiments, transmitter controller 150 may override the preferred, requested rectified voltage of receiver 200 and set a new preferred rectified voltage for receiver 200. For example, if transmitter 100 is capable of transmitting 100 W of power (e.g., 20 V at 5 A), and receiver 200 has requested 10 V at 2 A, transmitter 100 may over-ride the preferred receiver 200 voltage by transmitting 10 W of power (e.g., 5 V at 2 A) even though transmitter 100 is capable of transmitting 10 V at 2 A. Receiver controller 230 may then determine that the 5 V (e.g., at 2 A) is the new preferred rectified voltage for receiver 200.

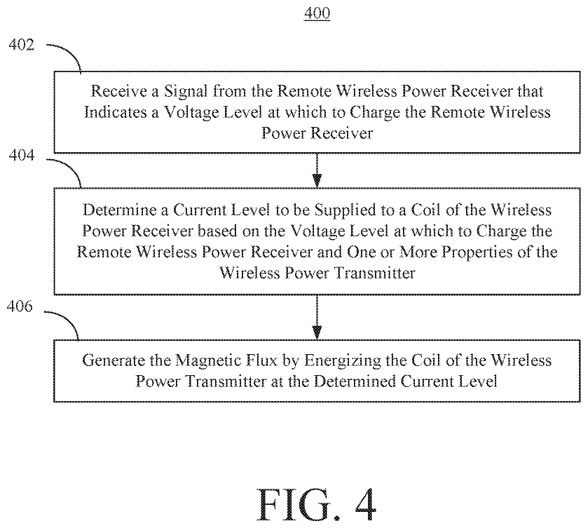

FIG. 4 is a flow chart of a process for communicating between a wireless power transmitter and a wireless power receiver, according to certain implementations. Process 400 begins at 402, where transmitter controller 150 receives a signal from receiver 200 that indicates a voltage level at which to charge the remote wireless power receiver. For example, transmitter controller 150 may receive a wireless communication signal from receiver 200 that contains data corresponding to the identity of receiver 200, the minimum voltage required for receiver 200 to power-on, a maximum voltage the receiver 200 is configured to accept, and/or a period of time over which transmitter 100 is to increase the power transmitted to receiver 200.

At 404, transmitter controller 150 determines a current level to be supplied to coil 210 of receiver 200 based on the voltage level at which to charge receiver 200 and one or more properties of transmitter 100. For example, transmitter controller 150 determines the current level by determining the minimum between (1) a maximum voltage the receiver 200 is configured to accept and (2) the maximum output power of wireless power transmitter 100.

At 406, transmitter 100 generates the magnetic flux by energizing the coil of the wireless power transmitter at the determined current level. For example, transmitter 100 generates the determined current level using phase modulation, duty cycle modulation, input voltage regulation, or frequency modulation of converter 120.

The systems and methods described above for communicating between wireless power receivers and transmitters improve upon known communication methods because they require less complex communication circuitry and no high-frequency, expensive communication circuitry. Therefore, the complexity and costs associated with designing and manufacturing wireless power receivers and transmitters is greatly reduced. Furthermore, communication can be one way (e.g., from the receiver 200 to the transmitter 100) reducing the need for redundant data to be transmitted from the transmitter 100 to receiver 200. Also, the signal and power output from the transmitter does not need to be frequency key shifted or amplitude key shifted. Even further, a separate communication channel (e.g., a Bluetooth channel) is not required. Therefore, in some embodiments, receiver controller 150 may be implemented on a cheaper, low-frequency microcontroller.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the invention.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose controller may be a microcontroller, but in the alternative, the controller may be any conventional processor, controller, microcontroller, or state machine. A controller may also be implemented as a combination of computing devices, e.g., a combination of a DSP and a microcontroller, a plurality of microcontrollers, one or more microcontrollers in conjunction with a DSP core, or any other such configuration. The steps of a method or algorithm and functions described in connection with the embodiments disclosed herein may be embodied directly in hardware, in a software module executed by a controller, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the controller such that the controller can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

1. A method of operation of a wireless power transmitter, the wireless power transmitter configured to generate a magnetic flux for wirelessly charging a remote wireless power receiver, the steps comprising of:
receiving a signal from the remote wireless power receiver that indicates a voltage level at which to charge the remote wireless power receiver;
determining a current level to be supplied to a coil of the wireless power transmitter based on the voltage level at which to charge the remote wireless power receiver and one or more properties of the wireless power transmitter; and
generating the magnetic flux by energizing the coil of the wireless power transmitter at the determined current level.

2. The method of claim 1, wherein the one or more properties of the wireless power transmitter is a maximum power the wireless power transmitter is configured to output.

3. The method of claim 2, wherein determining the current level comprises:
determining, based on the maximum power that the wireless power transmitter is configured to output, whether the wireless power transmitter can provide enough current to supply to the coil of the wireless power transmitter to provide the voltage level at which to charge the remote wireless power; and
if the wireless power transmitter cannot provide enough current, outputting the maximum amount of power that the wireless power transmitter is configured to output.

4. The method of claim 1, wherein the signal further comprises at least one of a value corresponding to a period of time, wherein the period of time corresponds to the time over which an increasing current is supplied to the coil until the increasing current is substantially equal to the current level, a threshold voltage currently received by the receiver, and a maximum voltage the receiver is configured to receive.

5. The method of claim 1, further comprising:
retrieving a value corresponding to a period of time, wherein the period of time corresponds to the time over which an increasing current is supplied to the coil until the increasing current is substantially equal to the current level.

6. The method of claim 4, further comprising:
increasing a current supplied to the coil over the period of time using at least one of phase modulation, duty cycle modulation, input voltage regulation, or frequency modulation.

7. The method of claim 4, wherein the period of time is less than 2 seconds.

8. The method of claim 1, wherein the signal is a first signal, further comprising:
receiving a second signal from the controller after a period of time has elapsed.

9. The method of claim 8, wherein the second signal comprises a request for more power to be transmitted from the wireless power transmitter.

10. The method of claim 8, wherein the second signal comprises a request for less power to be transmitted from the wireless power transmitter.

11. A wireless power transmitter, the wireless power transmitter configured to generate a magnetic flux for wirelessly charging a remote wireless power receiver, the wireless power transmitter comprising:
a coil;
a power converter configured to supply a current to the coil;
a controller configured to:
receive a signal from the remote wireless power receiver that indicates a voltage level at which to charge the remote wireless power receiver;
determine a current level to be supplied to the coil based on the voltage level at which to charge the remote wireless power receiver and one or more properties of the wireless power transmitter; and
instruct the power converter to supply the determined current level to the coil to generate the magnetic flux by energizing the coil.

12. The wireless power transmitter of claim 11, wherein the one or more properties of the wireless power transmitter is a maximum power the wireless power transmitter is configured to output.

13. The wireless power transmitter of claim 12, wherein when determining the current level, the controller is configured to:
determine, based on the maximum power that the wireless power transmitter is configured to output, whether the wireless power transmitter can provide enough current to supply to the coil of the wireless power transmitter to provide the voltage level at which to charge the remote wireless power; and
if the wireless power transmitter cannot provide enough current, output the maximum amount of power that the wireless power transmitter is configured to output.

14. The wireless power transmitter of claim 11, wherein the signal further comprises at least one of a value corresponding to a period of time, wherein the period of time corresponds to the time over which an increasing current is supplied to the coil until the increasing current is substantially equal to the current level, a threshold voltage currently received by the receiver, and a maximum voltage the receiver is configured to receive.

15. The wireless power transmitter of claim 11, wherein the controller is further configured to:
retrieve a value corresponding to a period of time, wherein the period of time corresponds to the time over which an increasing current is supplied to the coil until the increasing current is substantially equal to the current level.

16. The wireless power transmitter of claim 14, wherein the controller is further configured to:
increase a current supplied to the coil over the period of time using at least one of phase modulation, duty cycle modulation, input voltage regulation, or frequency modulation.

17. The wireless power transmitter of claim 14, wherein the period of time is less than 2 seconds.

18. The wireless power transmitter of claim 11, wherein the signal is a first signal, wherein the controller is further configured to:
receive a second signal from the controller after a period of time has elapsed.

19. The wireless power transmitter of claim 18, wherein the second signal comprises a request for more power to be transmitted from the wireless power transmitter.

20. The wireless power transmitter of claim 18, wherein the second signal comprises a request for less power to be transmitted from the wireless power transmitter.
